(19) United States
(12) Patent Application Publication
(10) Pub. No.: US 2007/0247867 A1
(43) Pub. Date: Oct. 25, 2007

(54) Portable LED Light Source for an Endoscope or Boroscope

(75) Inventors: James D. Hunter, Hilliard, FL (US); Johannes M. Blum, Orange Park, FL (US); Eric A. VanDenhende, Jacksonville, FL (US)

Correspondence Address: HOWSON AND HOWSON, SUITE 210, 501 OFFICE CENTER DRIVE, FT WASHINGTON, PA, 19034, US

(73) Assignee: Sunoptic Technologies LLC, Jacksonville, FL (US)

(21) Appl. No.: 11/379,614

(22) Filed: Apr. 21, 2006

(51) Int. Cl. G02B 6/00

(52) U.S. Cl. 362/551; 362/552; 362/555; 362/574; 362/577; 362/580

(57) ABSTRACT

A compact, lightweight, portable light source unit for an instrument used to visualize an interior of a hollow cavity is provided. The unit includes a housing having a connection means for removably coupling the unit to a light input post or the like of the instrument and a light emitting diode (LED) powered by at least one battery mounted within the housing. The unit also includes means for controlling or dissipating heat generated by operation of the LED.

### BACKGROUND OF THE INVENTION

The present invention relates to instruments for visualizing the interior of a hollow cavity, and more particularly, the present invention relates to a portable light source for such instruments.

Endoscopes and boroscopes are examples of instruments for visualizing the interior of a hollow cavity. Endoscopes are typically utilized in medical procedures to visualize the interior of a body cavity or organ, and boroscopes are typically utilized in non-medical procedures to visualize the interior of cavities within machinery and the like. Both require the use of a light source that connects to a proximal end of the scope. Conventional light sources include a filament lamp mounted within a box remote from the scope and connected to the scope via a fiberoptic cable or the like. Typically, the box is connected to an electrical outlet to power the lamp.

Attempts in the prior art have been made to utilize portable light sources. By way of example, U.S. Patent Application Publication No. 2002/0028986 A1 of Thompson describes a battery-operated, cordless, portable light source that mounts directly onto a scope. Also see U.S. Pat. No. 6,692,431 B2 and U.S. Patent Application Publication No. 2004/0147809 A1 of Kazakevich which describe a battery-operated solid state light source. The use of light emitting diodes (LEDs) in general are described in U.S. Patent Application Publication No. 2004/0246744 A1 of Krupa et al. and U.S. Pat. No. 6,730,019 B2 issued to Irion, U.S. Pat. No. 6,318,887 B1 issued to Matsumoto, U.S. Pat. No. 6,260,994 B1 issued to Matsumoto et al., and U.S. Pat. No. 6,656,112 B2 issued to Miyanaga.

Other light sources for endoscopes and/or boroscopes are described in U.S. Pat. No. 6,921,920 B2 issued to Kazakevich, U.S. Pat. No. 6,876,446 B2 issued to Taylor et al., U.S. Pat. Nos. 6,135,947 and 6,659,943 B2 issued to Watanabe et al., U.S. Pat. No. 6,712,760 B2 issued to Sano et al., U.S. Pat. No. 6,814,699 B2 issued to Ross et al., and U.S. Pat. No. 6,809,499 B2 issued to Solingen. In addition, U.S. Pat. No. 6,604,847 B2 describes a portable LED reading light device, U.S. Patent Application Publication No. 2005/0007772 A1 describes a LED flashlight, and U.S. Pat. No. 6,966,677 B2 describes a LED lighting assembly for use in a lighting fixture.

Although the above referenced endoscopes, boroscopes, and various light sources may be satisfactory for their intended purposes, there is a need for a compact, lightweight light source removably connectable to various instruments including endoscopes and boroscopes. Preferably, the light source should be battery-operated so that it is portable and so that it eliminates the requirement for a remote light box and associated umbilical light delivery cable and power cord. In addition, preferably the light source should have means for controlling and/or dissipating heat produced by operation of the light source so that the light source does not become uncomfortably hot to touch and handle by hand during periods of continuous use.

### BRIEF SUMMARY OF THE INVENTION

According to the present invention, a portable light source unit for an instrument used to visualize an interior of a hollow cavity is provided. The unit includes a housing having a connection means for removably coupling the unit to a light input post of the instrument. A light emitting diode (LED) and at least one battery for powering the LED are mounted within the housing. The unit also includes means for controlling or dissipating heat generated by operation of the LED.

According to some embodiments of the present invention, the housing of the portable light source can include a finned headpiece at one end thereof in which a single LED is mounted. The finned headpiece has sufficient mass and surface area to dissipate heat generated by the single LED. The headpiece can also define a port for removably receiving the light input post of the instrument, and the single LED can be mounted within the headpiece immediately adjacent and/or within the port without any intervening optical transmission elements therebetween.

According to some embodiments of the present invention, the means for controlling heat generated by the LED can include a current converter mounted within the housing and electrically coupled to the LED and battery to limit current applied to the LED to a predetermined amperage. Preferably, the current converter is a solid state current converter, and the predetermined amperage is less than a maximum amperage of the LED.

According to some embodiments of the present invention, an on/off switch can be located on an end of the housing opposite from the headpiece, and the housing, headpiece and on/off switch can cooperate to form a sealed, fluid-tight, portable light source unit that is operable when immersed within a liquid. In addition, some contemplated embodiments of the portable light source unit according to present invention have a compact bullet-like shape, weigh no more than about 3.5 ounces (100 grams), have a total length of no more than about 5 inches (12.7 cm), and have a maximum width or outer diameter of no more than about 1.25 inches (3.2 cm).

According to another aspect of the present invention, an instrument for visualizing an interior of a hollow cavity is provided. The instrument includes a scope body having a proximal end with a light input post, a distal end with a light output port, and an intermediate body section with a light transmission channel. The instrument also includes a portable light source unit removably connectable to the proximal end of the scope body. The light source unit can be any of those described above with respect to the present invention. The instrument can be an endoscope or a boroscope, and the light input post of the scope body can be a fiberoptic input post.

### BRIEF DESCRIPTION OF THE DRAWINGS

The features and advantages of the present invention should become apparent from the following description when taken in conjunction with the accompanying drawings, in which:

FIG. 1 is a perspective view of a portable light source unit according to the present invention;

FIG. 2 is a cross-sectional view of the portable light source unit along line 2-2 of FIG. 1 and includes a showing of the proximal end and light input post of the instrument according to the present invention; and

FIG. 3 is a cross-sectional view of the portable light source unit along line 3-3 of FIG. 2.

### DETAILED DESCRIPTION OF THE INVENTION

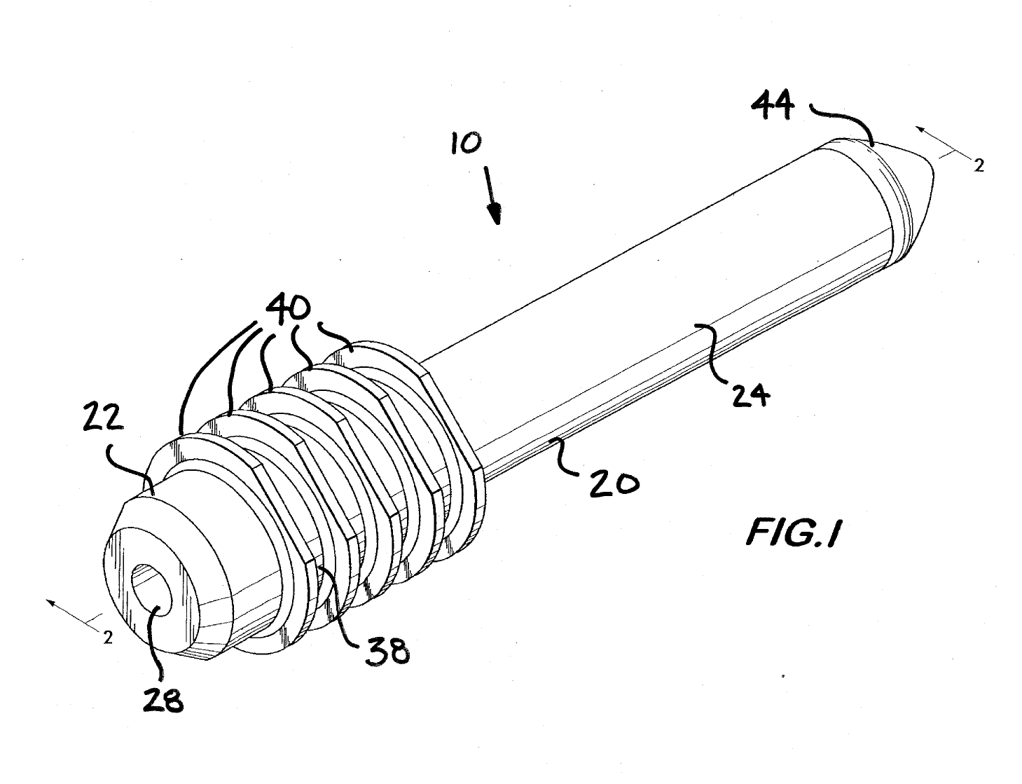

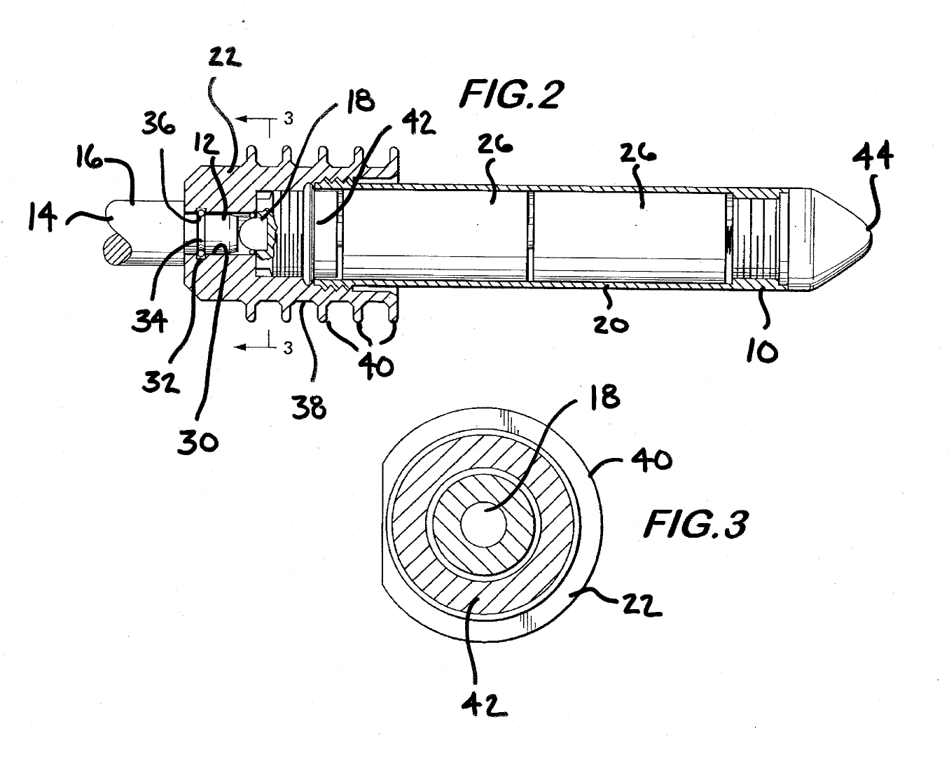

FIG. 1 illustrates a portable light source unit 10 according to the present invention. The unit 10 can be removably coupled to an input post 12 or like light input structure of an instrument 14 used to visualize the interior of a hollow cavity. For example, the instrument 14 can be an endoscope or a boroscope having a fiberoptic input post 12 at a proximal end 16 of the instrument 14. The light produced by unit 10 can be transmitted through the input post 12, through a light transmission channel (not shown) within an intermediate section of the instrument 14, and then be projected from a light output port (not shown) on a distal end (not shown) of the instrument 14 for illuminating the interior of a hollow cavity.

The portable light source unit 10 utilizes a light emitting diode (LED) 18 as its light producing source. In a preferred embodiment as illustrated, the unit 10 has only a single LED 18. In alternate embodiments of the present invention, more than one LED can be utilized or other solid state light sources equivalent to an LED can be utilized. An advantage of utilizing a single LED 18 is that it allows the unit 10 to be more compact, lightweight, and inexpensive to manufacture, and it effectively reduces the amount of heat capable of being generated during periods of extended continuous operation of the light source and enables the battery life to be extended.

By way of example, and not by way of limitation, the LED 18 can be a 3 watt LED that is capable of producing brilliant “daylight” quality light. The light can be of a color temperature of about 5500° K, and the LED can have a projected lamp life of about 100,000 hours.

The LED 18 is mounted within a sealed housing 20. As shown in the drawings, the housing 20 can include a headpiece 22 in which the LED 18 is mounted and a hollow body section 24 in which at least one battery 26 is carried. In the illustrated embodiment, a pair of batteries 26 is positioned end-to-end within the housing 20. Preferably, the headpiece 22 is located at one end of the hollow body section 24 of the housing 20. Other housing arrangements are also possible.

The headpiece 22 has a connection means by which the unit 10 can be connected to a proximal end 16 of the instrument 14. In the illustrated embodiment, the connections means is provided by a port 28 sized to receive a light input post 12 of the instrument. An interior wall 30 of the port 28 can have a circumferential groove 32, and the light input post 12 can have a corresponding circumferential groove 34 so that the input post 12 can be retained within the port 28 via a bracelet spring 36 or the like extending within the corresponding grooves, 32 and 34. Of course, any other coupling means by which the headpiece 22 can be removably coupled to the proximal end 16 of the instrument 14 can also be utilized. For example, the portable light source unit 10 can have a light input post which can be received within a port in the proximal end of the instrument.

The LED 18 can be mounted within the headpiece 22 such that it is immediately adjacent the light input post 12 when the light input post 12 is received within the port 28. Thus, no light transmission elements, such as fiberoptic cables or the like, are located between the light input post 12 and the LED 18. This arrangement ensures that substantially all the light produced by the LED 18 is transmitted into the light input post 12 without any significant loss.

Preferably, the headpiece 22 has an outer surface 38 with fins 40 or like heat dissipating structures extending therefrom. In the illustrated embodiment, the headpiece 22 is generally cylindrical and the fins 40 extend circumferentially about the headpiece 22 in a radially outward direction. Five fins 40 are shown in the drawings. Of course, more or less fins can be utilized and the fins can be of other shapes and extend in other directions and in other patterns on the headpiece. The finned headpiece 22 is of sufficient mass and has sufficient surface area to dissipate heat generated by the LED 18 mounted within the headpiece 22. Thus, even during periods of constant use of the LED 18, the portable light source unit 10 is of a comfortable temperature to touch and handle by hand.

By way of example, and not be way of limitation, the batteries 26 can be a pair of 3 volt Lithium batteries. Of course, other types of batteries or battery can be utilized. The batteries 26 can be disposable or rechargeable. Preferably, the batteries should provide at least about 90 minutes of run time between recharge or replacement.

For purposes of extending battery life and of controlling the amount of heat generated by the LED 18, the portable light source unit 10 can include a means of limiting the current capable of being applied to the LED 18 regardless of battery charge. As an example, a current converter 42, such as a solid state current converter, can be electrically coupled to the LED 18 and/or the battery 26 to ensure that the current actually applied to the LED 18 is at a predetermined amperage set to a level that is less than that permitted by the maximum capacity of the LED 18. In the illustrated embodiment, the current converter 42 is located directly between and engages the LED 18 and battery 26. This arrangement facilitates the unit 10 being provided in a compact form.

The current converter 42 and predetermined amperage enables the LED 18 to emit light of a constant brightness throughout the useful charge of the battery 26. When the batteries 26 become discharged and the current flowing through the LED is less than the predetermined amperage, the LED will slowly dim until the voltage drops below the minimum “forward voltage” characteristic of the LED, at which point the LED will no longer emit light. The dimming period provides ample warning that the batteries 26 need to be replaced and/or recharged.

In the illustrated embodiment of the present invention, an on/off switch 44 is mounted to an end of the hollow body section 24 of the housing 20 opposite from the headpiece 22. The switch 44 can be actuated to momentarily permit the LED 18 to be powered and illuminate or it can be actuated to power the LED 18 in a constant “on” mode. For example, pressing a plunger (not shown) of the switch 44 half way against a spring (not shown) actuates a momentary “on” mode, and pressing the plunger full way to a click stop places the LED 18 in a constant “on” mode. In the momentary “on” mode, releasing the plunger will turn off the LED 18, and in the constant “on” mode pressing the switch 44 again will release the plunger and return the LED 18 to an “off” mode. Of course, other on/off switches known in the art can be utilized.

The switch 44 in the illustrated embodiment has a cone shape thereby providing the unit 10 with an overall appearance of a so-called “bullet shape”. By way of example and not by way of limitation, the bullet shape can have a length of no more than about 5 inches (12.7 cm), a maximum width or outer diameter of no more than about 1.25 inches (3.2 cm), and can weigh no more than about 3.5 ounces (100 g) including batteries. Thus, a compact, lightweight, portable light source unit 10 can be provided. Preferably, the housing 20, headpiece 22, and switch 44 provide a fluid-tight, sealed unit 10 that is capable of use while being immersed within a fluid or liquid.

Various modifications can be made to the unit 10 and instrument 14 according to the present invention. For example, in some applications an LED 18 can be utilized that emits electromagnetic radiation other than that detectable by the eye. In addition, an LED can be selected that emits specific colors of light and/or infrared radiation or the like. Further, the arrangement of parts and/or the overall configuration of the unit can be modified.

While a preferred portable light source unit and instrument capable of being removably coupled to the portable light source unit have been described in detail, various modifications, alternations, and changes may be made without departing from the spirit and scope of the portable light source unit and instrument according to the present invention as defined in the appended claims.

1. A portable light source unit for an instrument used to visualize an interior of a hollow cavity, comprising:
a housing having a connection means for removably coupling the unit to a light input structure of the instrument;
a light source comprising a light emitting diode mounted within the housing;
at least one battery mounted within the housing for powering said light emitting diode; and
means for controlling or dissipating heat generated by operation of said light emitting diode.

2. A portable light source unit according to claim 1, wherein said light source consists only of a single light emitting diode.

3. A portable light source unit according to claim 2, wherein said connection means includes a port for receiving the light input structure of the instrument, and wherein said single light emitting diode is located adjacent or within said port without any intervening optical transmission elements therebetween.

4. A portable light source unit according to claim 1, wherein said means for controlling or dissipating heat includes a current converter that is mounted within the housing, that is electrically coupled to said light emitting diode and battery, and that limits current to said light emitting diode to a predetermined amperage.

5. A portable light source unit according to claim 4, wherein said predetermined amperage is less than a maximum amperage of said light emitting diode whereby heat generated by said light emitting diode is reduced, battery life is extended, and said light emitting diode produces light at a constant brightness during a useful charge of said battery.

6. A portable light source unit according to claim 5, wherein said current converter is a solid state current converter that engages and directly electrically interconnects said light emitting diode to said battery.

7. A portable light source unit according to claim 1, wherein said means for controlling or dissipating heat includes a headpiece of said housing having an outer surface with heat dissipating structures extending therefrom.

8. A portable light source unit according to claim 7, wherein said heat dissipating structures are a plurality of outwardly-extending spaced-apart fins, wherein said light emitting diode is mounted within said headpiece, and wherein said headpiece provides said connection means.

9. A portable light source unit according to claim 1, further comprising an on/off switch forming a distal end of said housing for turning on and off said light emitting diode.

10. A portable light source unit according to claim 1, wherein said housing of the unit is a sealed fluid-tight thereby permitting emersion of the unit within liquids.

11. A portable light source unit according to claim 1, wherein the unit is lightweight and weights no more than about 3.5 ounces (100 grams).

12. A portable light source unit for an instrument used to visualize an interior of a hollow cavity, comprising:
a housing having a headpiece at one end thereof, said headpiece defining a port for removably receiving a light input post of the instrument;
a light source consisting of a single light emitting diode mounted within the headpiece adjacent or within said port;
at least one battery mounted within the housing for powering said light emitting diode; and
a current converter mounted within said housing and electrically coupled to said light emitting diode and battery to limit current applied to said light emitting diode to a predetermined amperage to thereby control the amount of heat generated by operation of said light emitting diode.

13. A portable light source unit according to claim 12, wherein said headpiece has a set of spaced-apart, circumferentially-extending fins extending outwardly from an outer surface of said headpiece thereby providing said headpiece with sufficient mass and surface area to dissipate heat generated by said light emitting diode.

14. A portable light source unit according to claim 13, wherein said current converter is a solid state current converter, and wherein said predetermined amperage is less than a maximum amperage of said light emitting diode.

15. A portable light source unit according to claim 14, further comprising an on/off switch forming an end of said housing opposite from said headpiece.

16. A portable light source unit according to claim 15, wherein said housing, headpiece and on/off switch cooperate to form a sealed fluid-tight unit that is operable when immersed within a liquid.

17. A portable light source unit according to claim 16, wherein the unit is lightweight and has a compact bullet-like shape that weights no more than about 3.5 ounces (100 grams), is no longer than about 5 inches (12.7 cm), and has a maximum outer diameter of no more than about 1.25 inches.

18. A portable light source unit for an instrument used to visualize an interior of a hollow cavity, consisting essentially of:
a sealed fluid-tight housing having a heat dissipating finned headpiece at one end thereof and a substantially hollow body extending therefrom, said headpiece defining a port for removably receiving a light input post of the instrument;
a single light emitting diode mounted within the headpiece immediately adjacent or within said port;
at least one battery mounted substantially within the hollow body for powering said light emitting diode;
a solid state current converter mounted within said housing between said light emitting diode and said battery to limit current applied to said light emitting diode to a predetermined amperage; and
an on/off switch mounted on an end of said hollow body opposite from said headpiece.

19. An instrument for visualizing an interior of a hollow cavity, comprising:
a scope having a proximal end with a light input post, a distal end with a light output port, and an intermediate body section with a light transmission channel; and
a portable light source unit removably connectable to said distal end of said scope;
said unit having a housing with a heat dissipating finned headpiece at one end thereof, said headpiece defining a port for removably receiving said light input post;
said unit having only a single light emitting diode mounted within the headpiece adjacent or within said port;
said unit having at least one battery mounted within said housing for powering said light emitting diode; and
said unit having a current converter mounted within said housing and electrically coupled to said light emitting diode and battery to limit current applied to said light emitting diode to a predetermined amperage to thereby control the amount of heat generated by operation of said light emitting diode.

20. An instrument according to claim 19, wherein said scope is an endoscope or a boroscope, and wherein said light input post is a fiberoptic input post.
